(19) United States
(12) Patent Application Publication
(10) Pub. No.: US 2010/0154933 A1
(43) Pub. Date: Jun. 24, 2010

(54) APPARATUS FOR CONCURRENTLY SIZING, SQUARING, SHAPING, AND SANDING RECTANGULARY WORK PIECES

(76) Inventors: J. Melvon Hatch, JR., Taylorsville, UT (US); Jeff Hatch, West Jordan, UT (US)

Correspondence Address: TRASKBRITT, P.C., P.O. BOX 2550, SALT LAKE CITY, UT, 84110, US

(21) Appl. No.: 12/544,139

(22) Filed: Aug. 19, 2009

Related U.S. Application Data
(60) Provisional application No. 61/090,181, filed on Aug. 19, 2008.
(60) Provisional application No. 61/090,228, filed on Aug. 19, 2008.

(51) Int. Cl. B27C 5/04; B27C 1/12; B27C 5/06; B27C 9/00

(52) U.S. Cl. 144/360; 144/286.5; 144/4.9; 144/1.1

(57) ABSTRACT

An apparatus for machining the outer profiles of rectangular work pieces includes side and base fences for orienting a rough work piece upon a table. Edges of the rough work piece are cut (e.g., the rough work piece is sized), shaped, and optionally sanded while the rough work piece remains in place. The rough work piece may be rotated in a way that defines four square edges therefrom.

### CROSS-REFERENCE TO RELATED APPLICATIONS

A claim for priority is made to U.S. Provisional Patent Application Ser. No. 61/090,181, filed on Aug. 19, 2008, and to U.S. Provisional Patent Application Ser. No. 61/090,228, the entire disclosures of both of which are hereby incorporated herein by this reference.

### TECHNICAL FIELD

The present invention relates generally to apparatus for machining the outer profiles of rectangular work pieces. In particular, the present invention relates apparatus that are capable of squaring, shaping, and sanding at least edges of rectangular work pieces, such as panels, as are used in the manufacture of cabinet doors and other flat structures. The present invention also relates to methods for squaring, shaping, and sanding the edges of a rectangular work piece.

### RELATED ART

Wood panels are typically formed from strips of wood that have been glued side edge-to-side edge. Prior to being machined, the ends of the strips of wood may not be perfectly squared to the side edges of the outermost strips, the ends of adjacent strips may not be perfectly parallel to one another, and/or the ends of the strips at each end of the panel may be staggered. As a result of these irregularities, wood panels, in such a “rough” form, are often provided in slightly oversized dimensions (e.g., a 14″×20″ panel may have “rough” dimensions of about 14½″×20½″) and typically have to be cut and squared before they can be shaped and/or finished.

Rough panels are typically squared with a table saw that includes a single, elongate fence. An edge of a rough panel, which is not necessarily straight, is positioned against the fence while another, adjacent edge is cut with the saw blade. The rough panel is then rotated 90°, with the newly cut edge, which is known to be straight, being placed against the fence so that an adjacent edge may be cut. With the saw blade oriented perpendicular to the side fence, the next rough edge that is cut with the saw blade will be oriented perpendicular to (i.e., is squared to) the previously cut edge. The panel may then be rotated in the same manner until all four edges have been cut, with the result being a panel with four square, straight edges.

The squared panel must then be transferred to at least one additional apparatus, which shapes (e.g., shapes, profiles, raises, etc.) and optionally sands the edge of the panel, providing the panel with desired edge features.

### SUMMARY

The present invention includes apparatus that are equipped to squarely cut, size, and substantially simultaneously shape and optionally sand edges (e.g., the outer profiles) of a rough work piece (e.g., a rough panel of wood; an article of manufacture, such as a door, a cabinet face, or a cabinet door; etc.), which includes edges that are not straight or square or edges that are not known to be straight or square. For purposes of this disclosure the phrase “substantially simultaneous” and variations of that phrase refer to the cutting, shaping, and optional sanding of an edge of a work piece before the work piece is reoriented upon a support surface.

In some embodiments, an apparatus according to the present invention includes tools that are translatable along a tool path, a table for supporting a work piece, and a pair of perpendicularly oriented fences associated with the table. The tools include one or more saws and one or more shaping tools for forming features at or in the edges of a work piece, including, but not limited to tools that form features in the work piece by shaping, profiling (e.g., providing an edge of a panel with a shape along the x- and y-axes (i.e., height and width directions) of the panel, and raising (e.g., providing an edge of a panel with a shape along the z-axis (i.e., the thickness) of the panel). The apparatus may optionally include one or more sanding or other finishing tools. In some embodiments, one or more of the tools may move generally along a linear tool path, but in a plurality of axes, including directions that deviate somewhat from the tool path.

The table may be translated in directions perpendicular to the tool path. Thus, if the tool path travels in directions that are parallel to an x-axis, the table may be translated in directions that are parallel to a z-axis. Translation of the table may move an edge of a work piece into the tool path, and may be effected so that work pieces of different sizes may be used with the apparatus. In some embodiments, the table may be translated during cutting, shaping, or sanding to provide a work piece with features that are not straight (e.g., curved features, edges that are oriented at angles relative to the general direction in which the edge extends, etc.).

One of the fences, which is also referred to herein as a “side fence,” is oriented perpendicular to the tool path (e.g., along the z-axis), and may remain in a fixed position on or relative to the table. Another of the fences, which is also referred to herein as a “base fence,” is oriented parallel to the tool path (e.g., along the x-axis). The base fence may remain stationary as the table is translated. The base fences of some embodiments of apparatus of the present invention are configured to receive curved edges of work pieces.

In some embodiments, an apparatus that incorporates teachings of the present invention may include two parallel base fences at different locations to accommodate different sizes or size ranges of work pieces. In such embodiments, the base fence that is closest to the tool path may be raised and used when work pieces with smaller dimensions are to be cut and shaped with the apparatus, and lowered so that the table may accommodate work pieces with larger dimensions, in which cases the base fence that is located farthest from the tool path may be used.

The present invention also includes embodiments of methods for squaring rough work pieces and shaping the edges of the work pieces. In such methods, an edge of a work piece is cut and shaped and, optionally, sanded, while the work piece remains in place upon (e.g., stationary relative to) a table. Only after cutting, shaping, and optional sanding is the work piece moved (e.g., rotated to a different orientation) so that another edge of the work piece may be cut, sized, shaped, and optionally sanded. In some embodiments, movement of the work piece may comprise rotating the work piece 180° so that an opposite edge may be cut, sized, shaped, and optionally sanded. Such 180° rotation, when performed in connection with a noncontinuous alignment fence (e.g., a base fence that includes two or more pins), may be used to enable the squaring of a work piece in accordance with teachings of the present invention even when at least one edge of the work piece is cut and/or shaped to include features that are not straight (e.g., curved, etc.).

Other features and advantages, as well as various aspects, of the present invention will become apparent to those of ordinary skill in the art through consideration of the ensuing description, the accompanying drawings, and the appended claims.

### BRIEF DESCRIPTION OF THE DRAWINGS

In the drawings:

FIG. 1 is a perspective representation of an embodiment of an apparatus for cutting, sizing, squaring and shaping edges of a rough work piece in accordance with teachings of the present invention;

FIGS. 1A through 1C are front, rear, and top view of a specific embodiment of apparatus of the present invention;

FIG. 2 is a partial perspective view of an embodiment of side fence of a table of an apparatus of the type illustrated by FIG. 1;

FIG. 3 is a partial perspective view of another embodiment of side fence of a table of an apparatus of the type illustrated by FIG. 1;

FIG. 4 is a perspective representation of an embodiment of a table of an apparatus of the type shown in FIG. 1, in which the table includes two base fences;

FIG. 5 is a partial perspective view of a base fence of the table depicted by FIG. 4;

FIGS. 6 through 9 schematically depict an embodiment of a process for substantially simultaneously squarely cutting, shaping, and optionally sanding edges of a rough rectangular work piece;

FIG. 10 illustrates a variation of the process depicted by FIGS. 6 through 9, in which at least one of the first three edges of the work piece is cut, sized, shaped, and/or optionally sanded to have a non-straight configuration and may be accommodated by a configuration of the apparatus that effects the substantially simultaneous cutting, shaping, and optional sanding;

FIG. 11 depicts an embodiment of customizable curve according to the present invention; and

FIG. 12 illustrates another embodiment of customizable curve of the present invention.

### DETAILED DESCRIPTION

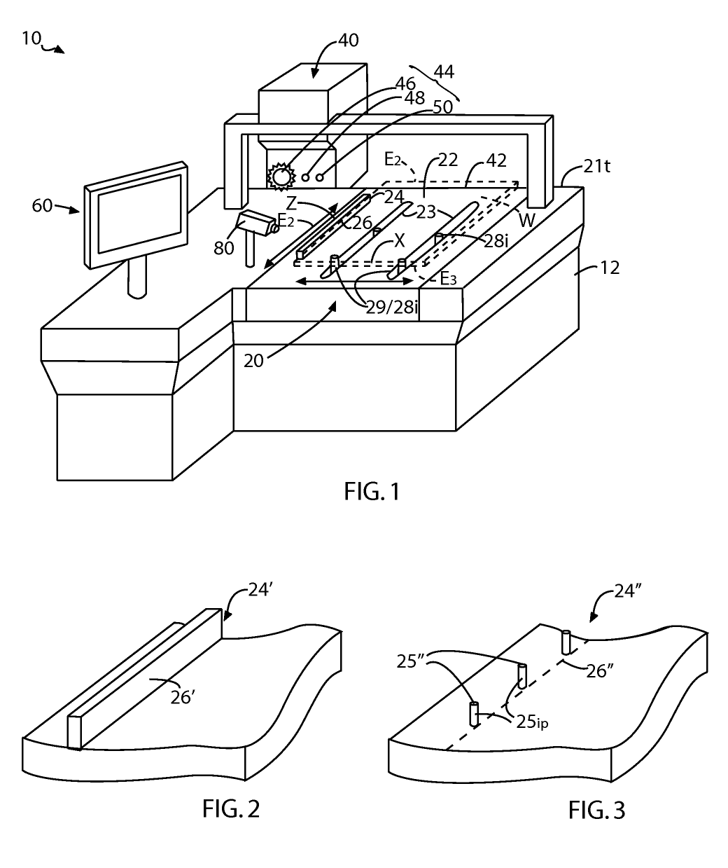

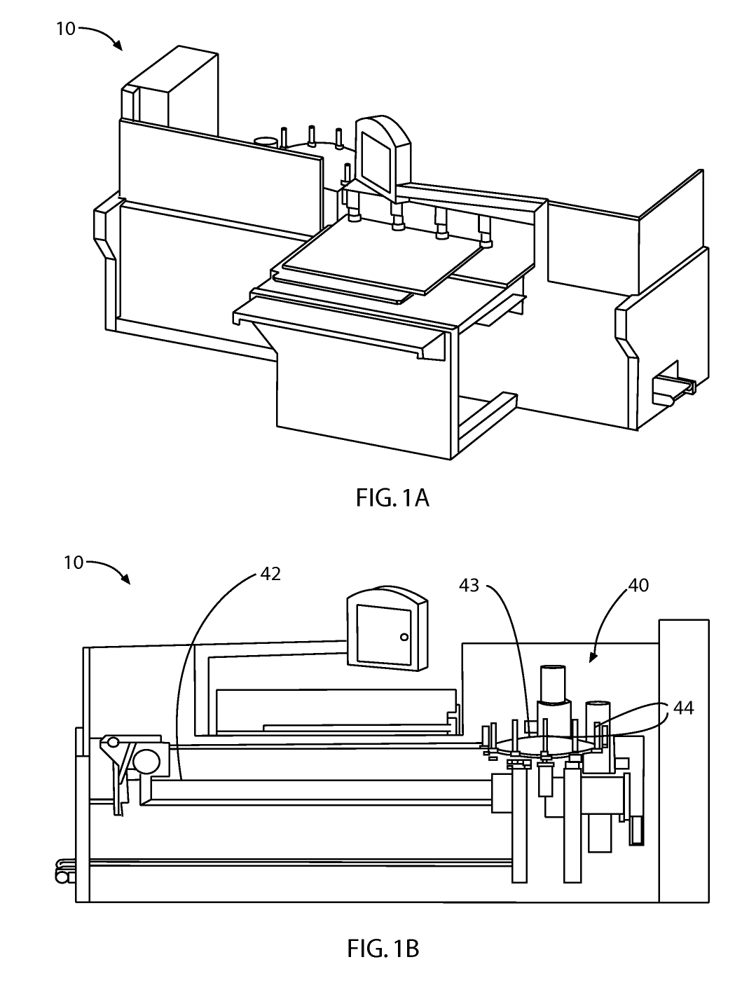

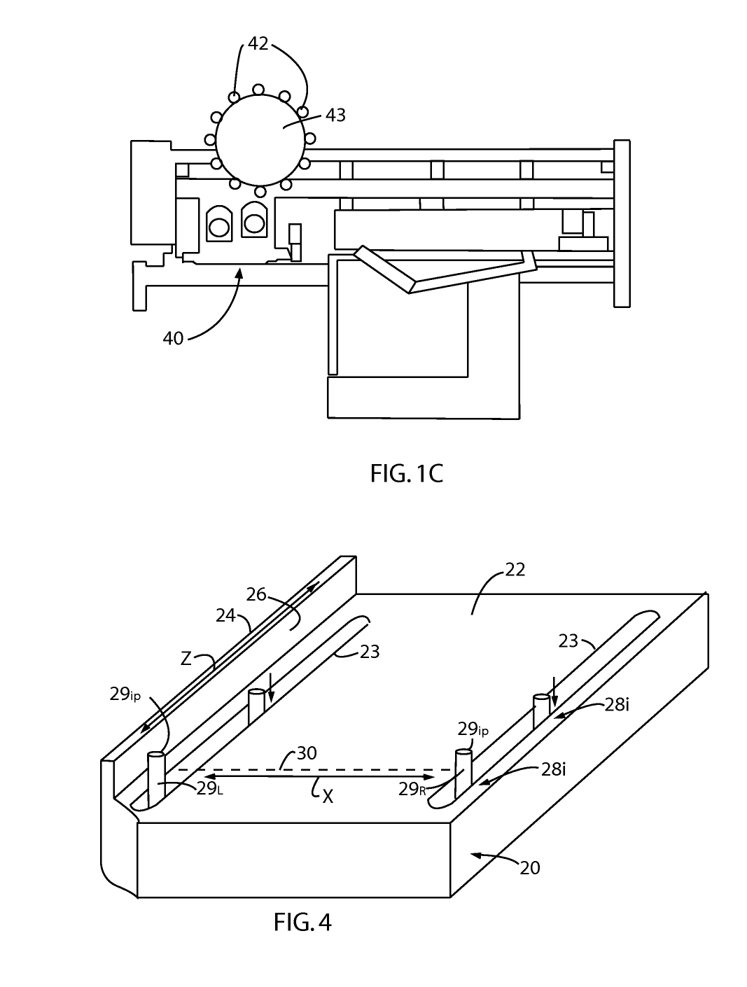

With reference to FIG. 1, an embodiment of an apparatus 10 for squaring and shaping edges of rough work pieces is schematically illustrated. A more specific embodiment of apparatus 10 is illustrated by FIGS. 1A through 1C.

Apparatus 10 includes a frame 12 that carries a table 20 and a tool assembly 40. Tool assembly 40 or elements (e.g., a saw, bits, etc.) thereof may be configured to move along a tool path 42 located adjacent to a top edge 21ₜ of table 20 and oriented parallel to an x-axis X. Thus, movement of tool assembly 40 may be considered to occur in “x-directions.” Frame 12 of apparatus 10 may also carry a control element 60, such as computer or computer processor, that communicates with and controls operation of table 20 and the various elements of tool assembly 40. In addition, control element 60 may include input and/or output devices (e.g., a touch sensitive monitor, etc.).

Table 20 includes a support surface 22 configured to receive and support a work piece W, such as a flat panel of wood or other material (e.g., high density fiberboard (HDF), medium density fiberboard (MDF), etc.) with edges that are to be squared and shaped. In some embodiments, support surface 22 is configured to receive a work piece W having a width of up to about 36 inches and a height of up to about 48 inches.

Table 20 may be moved relative to frame 12. In some embodiments, movement of table 20 may be confined to directions that are perpendicular to x-axis X, or parallel to the z-axis Z shown in FIG. 1. For purposes of this disclosure, the directions in which table 20 may be moved are also referred to as “z-directions.” In other embodiments, table 20 may also move in x-directions. Movement of table 20 relative to frame may be effected manually (e.g., by grasping one or more edges of table 20 and sliding it to a desired location, with mechanical assistance, such as one or more hand-operated cranks, etc) or automatically (e.g., with one or more motors, such as a servo motor).

A side fence 24 protrudes from support surface 22 of table 20 to prevent lateral movement (i.e., movement in a direction parallel to x-axis X, or in an x-direction) of work piece W as an edge E of work piece W (more specifically, edge E₁ in the depicted orientation of work piece W) is being cut and/or shaped. Side fence 24 includes an interior alignment edge 26 against which another edge E of work piece W (more specifically, edge E₂ in the depicted orientation of work piece W) is to be positioned when apparatus 10 is used to square and/or shape edges E of work piece W.

The position of side fence 24 relative to support surface 22 may, in some embodiments, be fixed (i.e., side fence 24 may move with table 20). In other embodiments, side fence 24 may remain stationary relative to frame 12 as table 20 is moved from one position to another (e.g., in a y-direction, in an x-direction, diagonally, etc.).

FIG. 2 illustrates an embodiment of a side fence 24′ that comprises an elongate element with a straight interior alignment edge 26′. Other embodiments of side fence 24″, such as that depicted by FIG. 3, include two or more pins 25″ with innermost points 25ᵢₚ that are aligned to define an interior alignment edge 26″.

With returned reference to FIGS. 1 through 1C, a table 20 of an apparatus 10 that incorporates teachings of the present invention may also include one or more base fences 28 that protrude from or that may be positioned to protrude from support surface 22 of table 20. Each base fence 28 includes an interior positioning edge 30 oriented along or parallel to z-axis Z. When a work piece W is positioned upon support surface 22 during use of apparatus 10, an edge E of work piece W (more specifically, edge E₃ in the depicted orientation of work piece W) is positioned against or adjacent to interior alignment edge 30, while the opposite edge E of work piece W (edge E₁ in the depicted embodiment) overhangs top edge 21ₜ of table 20. The distance that the opposite edge E overhangs top edge 21ₜ is defined by the location of base fence 28 upon support surface 22 of table 20.

In the depicted embodiment, table 20 includes two base fences 28ᵢ and 28ₗ. Base fence 28ᵢ may be used when smaller work piece W dimensions (e.g., work piece W dimensions of up to about 24 inches) are oriented along, or parallel to, z-axis Z. Accordingly, base fence 28ᵢ may be located at an intermediate position, along x-axis X, of support surface 22 of table 20. Due to its intermediate position, base fence 28, is also referred to herein as an “intermediate base fence.”

Base fence 28ₗ may be used when larger work piece W dimensions (e.g., work piece W dimensions of about 20 inches to about 42 inches) are oriented along, or parallel to, z-axis Z. Base fence 28ₗ may be located adjacent to a bottom edge 21_{b} of table 20 and, thus, is also referred to herein as a “lowermost base fence.”

In embodiments that include two or more base fences 28, each intermediate base fence (e.g., base fence 28ᵢ) may be raised and lowered, as shown in FIG. 4. Such raising and lowering may be effected manually or automatically. For example, one or more intermediate base fences may be raised and, thus, protrude from support surface 22 of table 20 when its use is desired or needed (e.g., when a relatively small, or short, edge of a work piece W is positioned adjacent to or against side fence 24). One or more intermediate base fences 28ᵢ may be lowered to or beneath the plane in which support surface 22 resides so that an effective support area of support surface 22 may increased to accommodate a work piece W that, when positioned as desired upon support surface 22 (e.g., when a relatively large, or long, edge of a work piece W is positioned adjacent to or against side fence 24), may extend beyond each lowered intermediate base fence 28ᵢ.

As shown in FIGS. 1 and 5, base fence 28 may, in some embodiments, comprise one or more pins 29 (two are shown) with innermost points 29ᵢₚ that are aligned to define interior positioning edge 30. In embodiments where base fence 28 includes two or more pins 29, an edge E of work piece W may be positioned securely against interior alignment edge 30 regardless of the configuration of edge E. More specifically, base fence 28 may be configured to receive an edge E that is not straight (e.g., an edge E that is curved, as depicted in FIG. 5; an edge E that includes sections oriented at angles relative to each other; etc.). The relative spacing between side fence 24 and a left pin 29_{L}, which is located closest to side fence 24, and the relative spacing between left pin 29_{L} and a right pin 29_{R} may, when work pieces W of certain dimensions (e.g., work pieces W that are about 14 inches wide) are cut, sized, shaped, and optionally sanded with apparatus 10, be useful for centering end edges E₁, E₃ that are not straight. In order to accommodate work pieces W of different widths, pins 29 may be configured to move laterally, along x-axis X or in directions that are parallel to x-axis X, relative to support surface 22 of table 20.

In a specific embodiment, a distance that each pin 29 protrudes from support surface 22 of table 20 may be fixed. In another specific embodiment, each pin 29 may be a spring-loaded element that, when an associated spring is in a relaxed state, is in a raised position but when a sufficient downward force is applied thereto (e.g., the weight of a work piece W positioned thereover) to overcome the force of the spring, the spring compresses and pin 29 is forced downward into table 20. Of course, a pin 29 that may be raised and lowered by other means, including selective mechanical and/or automatic means regardless of the application of a downward force, is also within the scope of the present invention, as are means for mechanically and/or automatically raising and lowering a pin 29.

In the embodiment depicted by FIGS. 1 and 5, each pin 29 may extend or be extendable from a location beneath table 20, through a corresponding elongate slot 23 formed in support surface 22, to a location beyond the plane in which support surface 22 resides. Each elongate slot 23 extends in directions parallel to z-axis Z (FIG. 1) to facilitate movement of table 20 in the z-directions, while pins 29 remain stationary relative to frame. Of course, embodiments in which at least some pins 29 and, thus, one or more base fences 28, move with table 20 are also within the scope of the present invention.

In other embodiments, the position of base fence 28 (e.g., of each pin 29) may be fixed relative to support surface 22 of table 20. In such embodiments, table 20 may be moved laterally (e.g., along the x- and z-axes) to accommodate work pieces of different sizes.

Other embodiments of base fence 28 are also within the scope of the present invention. In one such embodiment, base fence 28 may comprise an elongate fence with a linear interior edge.

As noted previously, tool assembly 40 is also carried by frame 12. Tool assembly 40 includes a plurality of tools 44, including at least one saw blade 46, at least one shaping bit 48, and, optionally, at least one sanding bit 50. In some embodiments, tool assembly 40 includes a tool changer 43 of a type known in the art (a rotatable tool changer is depicted in FIGS. 1B and 1C).

Tools 44 move generally along top edge 21ₜ of table 20, in x-directions. One or more tools 44, such as shaping bits 48 and sanding bits 50, if any, may also be configured to move along other axes. In a specific embodiment, shaping bits 48 and, optionally, sanding bits 50 of tool assembly 40 are parts of (e.g., secured to) so-called “8-axis tools,” which may be moved and oriented in a plurality of directions, as known in the art, to engage a work piece W in such a way as to cut, shape, or sand work piece W in a desired manner. The entire tool assembly 40 may move together with only selected tools 44 engaging work piece W, or tools 44 may be moved separately as they are used to engage and, thus, saw, shape, or sand and edge E of work piece W. Movement of tool assembly 40 and/or tools 44 may be effected by any suitable means or mechanism known in the art (e.g., by motors along at least one track, etc., and may be controlled by control element 60.

Tool assembly 40, or elements thereof, may be configured to cut, shape, and sand work piece edges that have straight configurations, as well as work piece edges that are not straight (e.g., are curved, include short, straight segments oriented at angles to each other, include a plurality of short curved segments, include combinations of straight and curved segments, etc.).

Control element 60 may be programmed in any suitable manner known in the art (e.g., with computer numeric control, or “CNC,” programming) to control the operation and movement of tools 44 and, in embodiments where table 20 moves, the movement of table 20 as well to provide an edge of a work piece W with a desired profile and/or shape.

In a specific embodiment, control element 60 may be programmed or configured to operate a program that enables a user to define a customized curve by receiving user inputs. In a more specific embodiment, control element 60 may display a customizable curve 110, 110′, such as that shown in FIG. 11 or FIG. 12, respectively, as well as information that enables an individual to customize the displayed curve by tailoring or manipulating the various segments of the displayed curve (e.g., by way of a input device of control element 60, such as a touch sensitive monitor, computer mouse, keyboard, etc.).

With reference to FIG. 11, an embodiment of a customizable curve 110 according to the present invention is shown. Customizable curve 110 includes a plurality of segments. In the depicted embodiment, the segments of customizable curve 110 include a central arc 120 and a pair 130 of side arcs 132 and 134. Side arcs 132 and 134 are continuous with opposite sides, or ends 122 and 124, respectively, of central arc 120.

Another embodiment of customizable curve 110′ that includes a plurality of segments is shown in FIG. 12. Like customizable curve 110, the segments of customizable curve 110′ include a central arc 120 with side arcs 132 and 134 on opposite ends 122 and 124 thereof. Customizable curve 110′ also includes two additional pairs 130′ and 130″ of side arcs 132′, 134′ and 132″, 134″, with side arcs 132′ and 132″ positioned on opposite sides of central arc 120 from, and at locations that correspond to the locations of, side arcs 134′ and 134″, respectively. In sequence, from left to right, customizable curve includes side arc 132″, side arc 132′, side arc 132, central arc 120, side arc 134, side arc 134′, and side arc 134″. For the sake of simplicity, each of side arcs 132, 132′, and 132″ may be referred to hereinafter as a “side arc 132” and each of side arcs 134, 134′, and 134″ may be referred to hereinafter as a “side arc 134.”

Of course, customizable curves with different numbers of arcuate segments, as well as customizable curves that includes non-arcuate features between two or more adjacent arcuate segments, are also within the scope of the present invention.

With continued reference to FIGS. 11 and 12, in various embodiments of the present invention, various parameters of a customizable curve 110, 110′ of the present invention may be defined. As an example an overall length L, L′ and height H, H′ of customizable curve 110, 110′ may be set. In addition, relative lengths L₁₂₀, L₁₃₀, L_{130′}, L_{130″} and heights H₁₂₀, H₁₃₀, H₁₃₀′, H_{130″} of each central arc 120 and side arc 132, 134 may be programmed. Such programming may be effected in any suitable manner, such as by entering numeric dimensions into a computer, use of a user manipulatable device (e.g., a a touch-sensitive screen, a computer mouse, etc.) to “drag” dimensional designators (e.g., dimension lines, cross-hairs, points, etc.) to desired locations, or by any other suitable means for defining the overall dimensions of customizable curve 110, 110′, as well as the dimensions of each segment of customizable curve 110, 110′.

The shape of each segment (e.g., of central arc 120) or pair of segments (e.g., each side arc 132, 134) of customizable curve 110, 110′ may also be defined. In some embodiments, the shape of each segment or pair of segments may be selected from a predetermined list of available shapes. In more specific embodiments, each segment may be a circular arc, or it may comprise an arc having one of number of available elliptical, parabolic, or hyperbolic shapes. In other embodiments, the shape of each segment or pair of segments may be user-defined, providing an infinite number of possible arcuate shapes. User-definition of the shape of a particular segment, may be effected by inputting data points into the formula for a particular type of arc (e.g., an elliptical arc, a parabolic arc, an hyberbolic arc, etc.) or by “manipulating” (e.g., by way of a touch sensitive screen, with a computer mouse, etc.) a graphic representation (e.g., an arc displayed on a computer monitor, etc.) of a particular type of arc (e.g., an elliptical arc, a parabolic arc, an hyberbolic arc, etc.), such as by “grabbing” and “dragging” a portion of the displayed arc and moving the same until the displayed arc has the desired shape.

In embodiments where customizable curve 110, 110′ is to be symmetrical, side arcs 132 and 134 may be simultaneously defined.

Transitions T between segments (e.g., between adjacent arcs 120, 132, 134) may also be smoothed. In some embodiments, each transition T may comprise a common point on ends of two adjacent segments. Smoothing of transition T may be effected by modifying the two adjacent segments in such a way that the common end points also share a common tangent. This type of smoothing may occur as an individual generates customizable curve 110, 110′. As an example, once the arcuate shape of a first segment (e.g., of central arc 120) is defined, the available arcuate shapes for adjacent segments (e.g., of side arcs 132 and 134) may be limited to arcuate shapes with end points that will share a common tangent with a tangent to the common end point of the first segment. As another example, as an individual selects a particular arcuate shape for a second segment or for a pair of second segments (e.g., for side arcs 132 and 134), a previously defined arcuate shape of another, first segment (e.g., of center arc 120) or pair of segments may be modified to maintain commonality between tangents to the common end points of the adjacent segments.

In other embodiments, transitions T may comprise “filler elements,” such as straight lines, curves, or discontinuities (e.g., features that are recessed relative to or protrude from customizable curve 110, 110′, etc.), that may be introduced between adjacent segments to produce a visually smooth transition therebetween.

As indicated, the foregoing methods may be embodied as programming of an apparatus that will define a structure that includes a customized curve. More specifically, the programming may receive user inputs, such as those noted previously herein, that will be used in defining the customized curve. In a specific embodiment, the programming generates computer numeric control (CNC) commands for controlling the operation of tools that remove material from a work piece to define the customized curve.

As noted previously, and with returned reference to FIGS. 1 through 1C, control element 60 also controls the operation of tool assembly 40, which defines the customized curve in a work piece 60 that is held in place upon support surface 22 of table 20.

With returned reference to FIG. 1, in embodiments of apparatus 10 that include a table 20 with base fences 28 with pins 29 that are selectively raised and lowered, control element 60 may also be programmed to control the means or mechanism by which raising and lowering of pins 29 of one or more base fences 28 is effected.

Apparatus 10 that incorporate teachings of the present invention may, in various embodiments, also include a number of other features. Examples of such features include, without limitation, clamps that are associated with table 20, an optical system associated with top edge 21ₜ of table 20 and in communication with control element 60 to sense when a work piece overhangs top edge 21ₜ by an undesirably large distance, scrap removal apparatus (e.g., a conveyor), guards, automated (e.g., robotic) work piece handling apparatus, and the like.

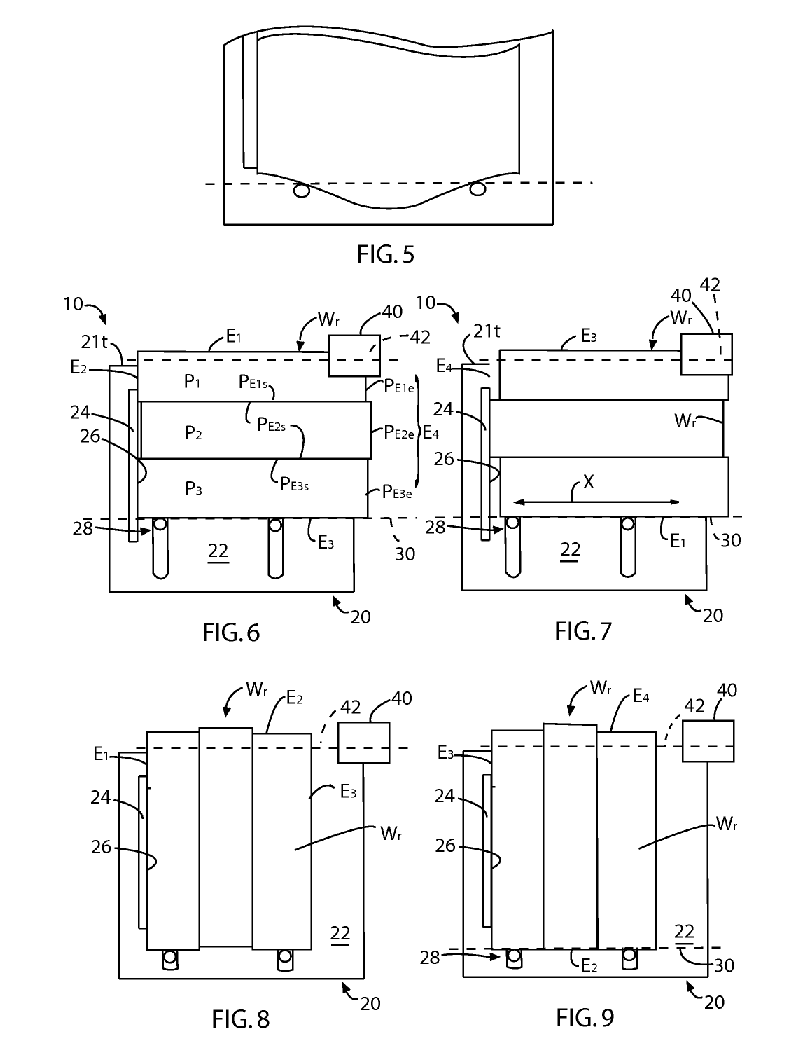

Turning now to FIGS. 6 through 9, an embodiment of a method for substantially concurrently squaring, shaping, and optionally sanding edges of a rough rectangular work piece Wᵣ is depicted. While the depicted method embodiment employs an apparatus 10 of the present invention, the method is not limited to use of the depicted embodiment of apparatus 10.

As shown in FIG. 6, a rough rectangular work piece Wᵣ is placed upon a support surface 22 of a table 20 of an apparatus 10 for squaring, shaping, and optionally standing edges of rough rectangular work piece Wᵣ. In the illustrated example, rough rectangular work piece Wᵣ includes a plurality of elongate panels P₁, P₂, P₃ with long, side edges P_{E1s}, P_{E2s}, P_{E3s}, respectively, that have been secured to one another in a manner known in the art (e.g., by tongue and groove fittings secured with adhesive, etc.). As shown, one or more outer side edges E₂, E₄ of rough rectangular work piece Wᵣ may not be straight. In addition, short edges, or ends P_{E1e}, P_{E2e}, P_{E3e}, of panels P₁, P₂, P₃ may not be aligned or oriented square to side edges E₂, E₄ of rough rectangular work piece Wᵣ. Thus, end edges E₁, E₃ of a rough rectangular work piece Wᵣ may not be straight or square to one or both side edges E₂, E₄. Due to a great deal of variability between rough rectangular work pieces Wᵣ that are to be used for a particular purpose (e.g., as center panels for cabinet doors, etc.), but the desirability of work pieces that have uniform dimensions, it would be highly desirable, even necessary, to ensure that edges E₁-E₄ are straight and square.

In the embodiment illustrated by FIG. 6, a side edge E₂ of rough rectangular work piece Wᵣ may initially be placed against an interior alignment edge 26 of a side fence 24 of table 20 of apparatus 10, while an end edge E₃ of rough rectangular work piece Wᵣ is positioned against an interior alignment edge 30 of base fence 28. With rough rectangular work piece Wᵣ secured in position upon support surface 22 of table 20, an end edge E₁ of rough rectangular work piece Wᵣ adjacent to (e.g., that overhangs) and substantially aligned with top edge 21ₜ of table 20, and located within tool path 42, may be cut, sized, shaped, and optionally sanded. Cutting may be effected with a saw 46 of tool assembly 40, while one or more shaping bits 48 may be used to shape edge E₁ and one or more sanding bits 50 may be used to sand edge E₁. Notably, the acts of cutting and shaping are effected before reorienting rough rectangular work piece Wᵣ upon support surface 22.

Once edge E₁ has been cut, sized, shaped, and optionally sanded, rough rectangular work piece Wᵣ may be reoriented (e.g., rotated) upon support surface 22 of table 20, as illustrated by FIG. 7. In some embodiments, rough rectangular work piece Wᵣ may be rotated 180°, such that edge E₄ is positioned against interior alignment edge 26 of side fence 24 and edge E₁ is positioned against interior alignment edge 30 of base fence 28. Once rough rectangular work piece Wᵣ has been reoriented upon support surface 22 of table 20, as shown in FIG. 7, an opposite end edge E₃, which is substantially parallel to x-axis X and is located adjacent to top edge 21ₜ of table 20, within tool path 42 (e.g., overhangs top edge 21ₜ, is located over a cutout in support surface 22, etc.), may be cut, sized, shaped, and optionally sanded while remaining in the illustrated orientation. In embodiments where both end edges E₁ and E₃ are straight, they will be parallel to one another.

Rough rectangular work piece Wᵣ may then reoriented upon support surface 22 of table 20; for example, by rotating the same 90° to place edge E₃ adjacent to tool path 42, as illustrated by FIG. 8. At least one edge E₁, E₃ that has been cut, sized, shaped, and optionally sanded may be straight (both edge E₁ and edge E₃ are straight in the depicted embodiment). By positioning an edge (e.g., edge E₁ in the illustrated embodiment) that is known to be straight against interior alignment edge 26 of side fence 24, tool path 42 will be oriented perpendicular to that edge E₁. Accordingly, when edge E₃ is cut, sized, shaped, and optionally sanded, as illustrated by FIG. 8, it will be perpendicular to and, thus, square with edges E₁ and E₃.

Finally, with reference to FIG. 9, rough rectangular work piece Wᵣ is again reoriented upon support surface 22 of table 20, this time by rotating rough rectangular work piece Wᵣ 180° so that tool path 42 traverses rough rectangular work piece Wᵣ at a location adjacent to edge E₄. In the embodiment illustrated by FIG. 9, edge E₂ is positioned against interior alignment edge 30 of base fence 28, while edge E₃ abuts interior alignment edge 26 of side fence 24. In embodiments where edges E₂ and E₃ are both straight, the squareness of these to edges relative to each other may be verified as they are positioned against interior alignment edges 30 and 26 of base fence 28 and side fence 24, respectively. Once rough rectangular work piece Wᵣ has been oriented upon support surface 22, it may be cut, sized, shaped, and optionally sanded with tools 44 of tool assembly 40.

In some embodiments, one or more edges E₁-E₄ of a rough rectangular work piece Wᵣ may not be straight following the cutting, shaping, and/or optional sanding processes. In more specific embodiments, such non-straight edges may be curved and, in even more specific embodiments, have a customized curve, as described in reference to FIGS. 11 and 12. When an embodiment of apparatus 10 according to the present invention is used to squarely cut, shape, and optionally sand a rough rectangular work piece Wᵣ, such non-straight edges may be formed by movement of one or more tools 44 into and out of tool path 42, by movement of table 20 and a rough rectangular work piece Wᵣ thereon relative to tool path 42 during sawing, shaping, and/or optional sanding, or by a combination of the movement of tools 44 and table 20.

Such non-straight edges may be formed at the end of the process (e.g., in cutting, shaping, and optionally sanding edge E4, as shown in FIG. 9). In other embodiments, including, but not limited to, embodiments in which more than one edge is cut, sized, shaped, and/or sanded to have a configuration that is not straight, the non-straight edge (e.g., edge E₁, E₂, or E₃) may be formed at any earlier point in the process of substantially simultaneously squaring and shaping edges of a rough work piece Wᵣ.

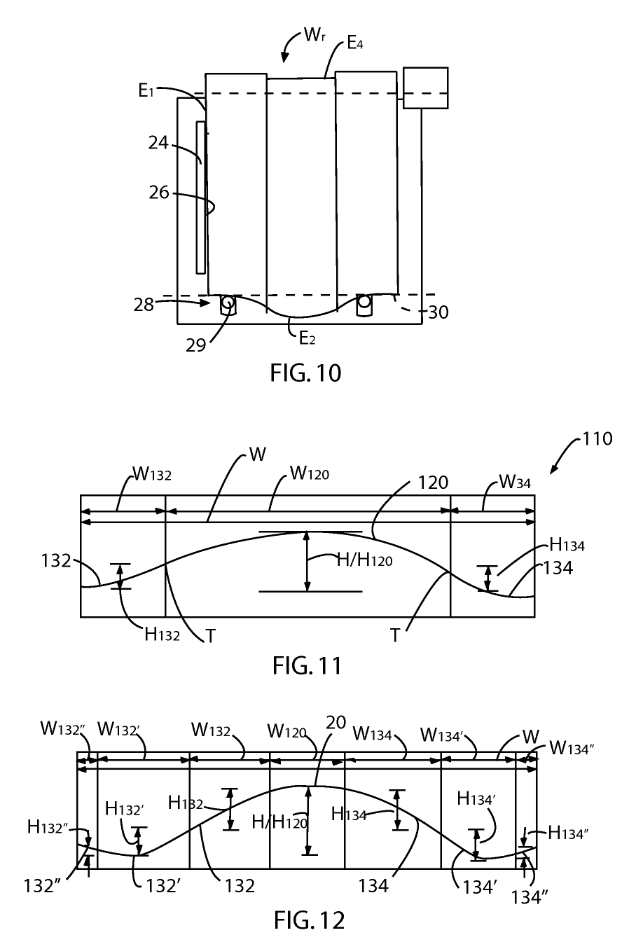

FIG. 10 provides a non-limiting example of an embodiment in which edge E₂ is cut, sized, shaped, and/or optionally sanded (see FIG. 8) to have a non-straight configuration. In the depicted embodiment, following the acts of cutting, shaping, and optional sanding, edge E₃ has a smooth curve, although embodiments in which edge E₂ has other non-straight configurations, such as a plurality of straight angled sections, a plurality of curved sections, or combinations of curved and straight sections are also within the scope of the present invention.

Since edge E₂ has a convex curve, a portion of rough rectangular work piece Wᵣ (i.e., the apex of the curve) may positioned between pins 29 of base fence 28 as rough work piece Wᵣ is reoriented upon support surface 22 of table 20 in preparation for cutting, shaping, and optional sanding of edge E₄. Because of base fence 28 comprises pins 29, edges (e.g., edge E₂) of a rough rectangular work piece Wᵣ that are not straight may be positioned securely against interior alignment edge 30 of base fence 28 without interrupting the process of squaring the edges E of rough rectangular work piece Wᵣ. In some embodiments, by merely positioning a “reference edge” (i.e., edge E1) that has been previously cut, sized, shaped, and optionally sanded, and that is known to be straight, against interior alignment edge 26 of side fence 24 will be enough to ensure that the next adjacent edge (e.g., edge E4) that is to be cut, sized, shaped, and optionally sanded will be perpendicular to and, thus, square with the reference edge.

In other embodiments, including, without limitation, embodiments in which a reference edge (e.g., edge E₂ or edge E₁) may not be straight, if the reference edge has a symmetrical configuration, it may be centered between pins 29 (or pins of a side fence 24′ for edge E₁; see FIG. 3), either visually and manually, or with the assistance of an optical recognition system 80, or machine vision system, of a type known in the art (e.g., a system available from Cognex Corporation of Natick, Mass.) that compares the actual location of a reference edge (e.g., edge E₂ in the depicted embodiment) to its centered location to determine whether or not reference edge E₂ is properly positioned and, thus, whether or not rough rectangular work piece Wᵣ is properly oriented upon support surface 22. If reference edge E₂ is not centered relative to pins 29, the orientation of rough rectangular work piece Wᵣ upon support surface 22 may be adjusted until rough rectangular work piece Wᵣ is properly oriented.

Once a rough rectangular work piece Wᵣ with a non-straight edge has been properly oriented, processing may continue in the manner described above.

Although the foregoing description contains many specifics, these should not be construed as limiting the scope of the present invention, but merely as providing illustrations of some embodiments. Similarly, other embodiments of the invention may be devised which do not exceed the scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

What is claimed:

1. An apparatus for squaring and milling edges of a work piece, comprising:
a table for supporting a work piece;
a first fence oriented along a first axis and configured to orient an edge of the work piece along the first axis;
a second fence oriented along a second axis, perpendicular to the first axis, configured to abut another edge of the work piece and to define a position of the work piece along the first axis;
a plurality of tools, including at least one saw blade and at least one milling tool, that are translatable in a direction parallel to the second axis at a location that will engage an edge of the work piece opposite from the edge of the work piece that abuts the second fence.

2. The apparatus of claim 1, wherein the table is laterally translatable in a direction parallel to the first axis.

3. The apparatus of claim 2, wherein the second fence is configured to move in directions parallel to the first axis.

4. The apparatus of claim 3, wherein the second fence is configured to selectively move in the first direction with the table as the table is translated in the first direction and to selectively remain stationary as the table is translated in the first direction.

5. The apparatus of claim 1, wherein the second fence includes at least two pins that are positioned along the second axis and oriented substantially vertically.

6. The apparatus of claim 5, wherein each pin of the at least two pins may be moved to a plurality of positions along the second axis.

7. The apparatus of claim 5, wherein the at least two pins are configured to receive a curved edge of the work piece.

8. The apparatus of claim 1, wherein the plurality of tools further includes at least one sanding tool.

9. A method for squaring and milling edges of a workpiece with a single machine, comprising:
providing a rough work piece with a substantially rectangular shape;
positioning adjacent edges of the rough work piece against adjacent, perpendicularly oriented fences, with a first side edge of the rough work piece positioned against a first fence oriented along a first axis and an end of the rough work piece positioned against a second fence oriented along a second axis perpendicular to the first axis;
positioning a second side edge of the rough work piece, opposite from the first side edge, in a tool path oriented parallel to the first axis;
translating a cutting tool along the tool path to cut the second side edge in the tool path and form a second straight side edge;
without rotating the rough work piece, translating a milling tool along the tool path to mill the second straight side edge;
rotating the rough work piece 180° with the second straight side edge oriented parallel to and positioned against the first fence;
positioning the first side edge in the tool path;
translating the cutting tool along the tool path to cut the first side edge to form a first straight side edge;
without rotating the rough work piece, translating the milling tool along the tool path to mill the first straight side edge;
rotating the rough work piece 90° with a straight side edge oriented parallel to and positioned against the second fence;
positioning an end edge of the rough work piece in the tool path;
translating the cutting tool along the tool path to cut the end edge;
without rotating the rough work piece, translating the milling tool along the tool path to mill the end edge;
rotating the rough work piece 180° with an opposite straight side edge oriented parallel to and positioned against the second fence;
positioning an opposite end edge of the rough work piece in the tool path;
translating the cutting tool along the tool path to cut the opposite end edge; and
without rotating the rough work piece, translating the milling tool along the tool path to mill the opposite end edge.

10. The method of claim 9, wherein at least one of translating the cutting tool along the cutting path to cut the end edge and translating the cutting tool along the cutting path to cut the opposite end edge comprises cutting a curved edge.

11. The method of claim 10, wherein rotating the work piece 180° with the opposite straight side edge oriented parallel to and positioned against the second fence comprises receiving a curved portion of the curved edge between a pair of adjacent pins comprising at least a portion of the first fence.

12. The method of claim 9, wherein translating the cutting tool along the cutting path to cut the end edge and translating the cutting tool along the cutting path to cut the opposite end edge comprise cutting curved edges from the end edge and the opposite end edge.

13. The method of claim 12, wherein rotating the work piece 180° with the opposite straight side edge oriented parallel to and positioned against the second fence comprises receiving a curved portion of a curved edge of the end edge between a pair of adjacent pins comprising at least a portion of the first fence.

14. The method of claim 9, further comprising sanding each edge immediately after milling that edge and before rotating the rough work piece.

15. An apparatus for squaring and milling edges of a work piece, comprising:
a table for supporting a work piece and translatable along a first axis;
a first fence oriented parallel to the first axis direction and configured to orient an edge of the work piece parallel to the first axis;
a second fence oriented along a second axis, perpendicular to the first axis, configured to abut another edge of the work piece and to define a position of the work piece along the first axis, the second fence comprising at least two vertically oriented pins that are positionable at a plurality of locations along the second axis and that selectively:
move in directions parallel to the first axis as the table is translated along the first axis; and
remain stationary as the table is translated along the first axis;
a plurality of tools, including at least one saw blade and at least one milling tool, that are translatable in a direction parallel to the second axis at a location that will engage an edge of the work piece opposite from the edge of the work piece that abuts the second fence.

16. The apparatus of claim 15, wherein the at least two pins are configured to receive a curved edge of the work piece.

17. The apparatus of claim 15, wherein the plurality of tools further includes at least one sanding tool.

18. A woodworking apparatus, comprising:
a frame;
a support carried by the frame;
a tool assembly adjacent to the support; and
a controller in communication with the tool assembly, the controller including at least one processing element, an output device, and an input device, the at least one processing element being programmed to generate a customizable curve under control of a user and to cause the tool assembly to form the customizable curve in or from a work piece held by the support.

19. The woodworking apparatus of claim 5, wherein the customizable curve includes:
a central arc;
at least one pair of side arcs, with the side arcs being located on opposite sides of the central arc; and
a visibly smooth transition between the central arc and each adjacent side arc.
